(19) United States
(12) Patent Application Publication
(10) Pub. No.: US 2018/0082250 A1
(43) Pub. Date: Mar. 22, 2018

(54) Location Based Shopping and Delivery System

(71) Applicant: James S. Cho, Westford, MA (US)

(72) Inventor: James S. Cho, Westford, MA (US)

(21) Appl. No.: 15/272,148

(22) Filed: Sep. 21, 2016

(51) Int. Cl. G06Q 10/08; G06Q 30/06

(52) U.S. Cl. CPC G06Q 10/0835; G06Q 30/0601

(57) ABSTRACT

A computerized system is provided for coordinating purchase and delivery of items from a store by a shopper who is already in or on the way to the store. The shopper is selected to be someone having a destination near the customer's delivery location. The system may automatically identify and put the customer and shopper in touch through the system to coordinate timing, delivery location, payment, and tracking of progress.

### BACKGROUND

### Field of the Invention

The subject matter described herein relates generally to shopping and delivery services. More particularly, the present invention relates to a system allowing customers to request delivery of certain items by a user who can deliver these items with limited inconvenience.

### Description of Related Art

In today's busy world, travelling to a store to shop for desired or needed items can be highly inconvenient. In some cases, certain stores such as grocery stores provide a delivery service. However, that service typically involves high costs, inconvenient delivery times, product markup, and user interface limitations.

In many cases, people in a person's neighborhood or within a certain distance are often going to a store such as a grocery store at any given time. If a system were invented to contact such people and coordinate shopping and delivery, the system would both allow a shopper to do his or her own shopping and also another user's. Costs could be decreased because the shopper is not a dedicated worker, and has a shorter delivery distance because he or she is going to be in the person's neighborhood anyway. Further, there is no product markup because the shopper is doing the purchasing directly.

Therefore, what is needed is a computerized system that identifies when a shopper is at or near a store, and allows a customer to provide a list of shopping items for the shopper to purchase for delivery to the customer.

### SUMMARY

The subject matter of this application may involve, in some cases, interrelated products, alternative solutions to a particular problem, and/or a plurality of different uses of a single system or article.

In one aspect, a system for coordinating item shopping and delivery is provided. The system includes a computerized alerting device, which has a processor, a memory, an alerting mechanism, a location module configured to determine a coordinates of a physical location of the computerized alerting device, a touch screen display, and a battery providing power to the device. This alerting device is in wireless communication with a computerized server. The communication between the server and the alerting device may involve a recordation of the determined location of the computerized alerting device by the server allowing the server to be aware of the location of the alerting device. This centralized server is configured to provide a notification to the alerting device when the alerting device's location is within a predetermined zone (as defined by a coordinate range) around a retail store. The predetermined zone, in varied embodiments may be a zone at a certain distance or space about the store, may be in a parking lot around the store, may be within the store itself, may be bounded at store entrance and exits, and the like. The notification typically will comprise a request for a purchase of items from the retail store for a customer making the request and potentially a number of items requested and/or delivery destination and/or distance. The server is configured to limit a group of customers from which the user receives notification requests from by calculating a “neighbor group” of system customers. The neighbor group is calculated based on data stored on the server, and takes into account at least one of a delivery location that is in proximity to a user's destination, or a delivery location that is close to the user's path to destination. Therefore, the server is configured to send the request for the purchase of items from the retail store to the user's computerized alerting device only if the request comes from a customer of the calculated neighbor group of customers.

### BRIEF DESCRIPTION OF THE DRAWINGS

FIG. 1 provides a schematic view of an embodiment of the present invention.

FIG. 2 provides a flow chart of an embodiment of use of the present inventive system.

FIG. 3 provides a flow chart of another embodiment of use of the present inventive system.

FIG. 4 provides a flow chart an embodiment of a payment process of the present invention.

FIG. 5 provides a view of an embodiment of user tracking of the present invention.

FIG. 6 provides a data flow of an embodiment of a user tracking of the present invention.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

In referring to the description, specific details are set forth in order to provide a thorough understanding of the examples disclosed. In other instances, well-known methods, procedures, components and materials have not been described in detail as not to unnecessarily lengthen the present disclosure.

It should be understood that if an element or part is referred herein as being “on”, “against”, “in communication with”, “connected to”, or “coupled to” another element or part, then it can be directly on, against, in communication with, connected or coupled to the other element or part, or intervening elements or parts may be present. When used, term “and/or”, includes any and all combinations of one or more of the associated listed items, if so provided.

The terminology used herein is for the purpose of describing particular embodiments only and is not intended to be limiting. As used herein, the singular forms “a”, “an”, and “the”, are intended to include the plural forms as well, unless the context clearly indicates otherwise. It should be further understood that the terms “includes” and/or “including”, when used in the present specification, specify the presence of stated features, integers, steps, operations, elements, and/or components, but do not preclude the presence or addition of one or more other features, integers, steps, operations, elements, components, and/or groups thereof not explicitly stated.

Some embodiments of the present invention may be practiced on a computer system that includes, in general, one or a plurality of processors for processing information and instructions, RAM, for storing information and instructions, ROM, for storing static information and instructions, a data storage unit such as a magnetic or optical disk and disk drive for storing information and instructions, modules as software units executing on a processor, an optional user output device such as a display screen device (e.g., a monitor) for display screening information to the computer user, and an optional user input device.

As will be appreciated by those skilled in the art, the present examples may be embodied, at least in part, a computer program product embodied in any tangible medium of expression having computer-usable program code stored therein. For example, some embodiments described below with reference to flowchart illustrations and/or block diagrams of methods, apparatus (systems) and computer program products can be implemented by computer program instructions. The computer program instructions may be stored in computer-readable media that can direct a computer or other programmable data processing apparatus to function in a particular manner, such that the instructions stored in the computer-readable media constitute an article of manufacture including instructions and processes which implement the function/act/step specified in the flowchart and/or block diagram. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In the following description, reference is made to the accompanying drawings which are illustrations of embodiments in which the disclosed invention may be practiced. It is to be understood, however, that those skilled in the art may develop other structural and functional modifications without departing from the novelty and scope of the instant disclosure.

Generally, the present invention concerns a system and device for providing instruction of items to purchase at a retail establishment (hereinafter a “store”) by a user who may then deliver the purchased items to a customer. The invention is configured to automatically select and prioritize users who have a destination or a path to his or her destination that is within a predetermined geographic proximity to the customer. For example, users may live in the same neighborhood as the requesting customer, or may reside along a path towards the user's home. In many embodiments, the system may utilize a device configured to automatically alert the user of a potential customer when the user enters a store, or enters a zone that extends a predetermined distance from the store (i.e. when a user is near a store, or driving by a store).

In varying embodiments, the present invention involves a system and/or new computerized device that can use geographic location, and proximity combined with communication with a networked server to alert or automatically alert users of potential customers that they may purchase items for, and deliver these items. The system may operate by communicating a location from a computerized device equipped with a location module to a server. The location module may be a signal receiving device including, but not limited to a GPS (global positioning system) receiver, a cellular signal receiver (utilizing, for example, triangulation, or similar location determining calculations), and a Wifi signal receiver.

The server may then automatically transmit a data structure comprising options for items to purchase and information regarding the customers back to the device of the user. The user may then elect to purchase certain items for certain customers, and may instruct the device to send a data structure back to the server indicating the elected items and/or users.

The present invention utilizes a computerized system to solve a number of technical problems that are significantly more than generic computer functions. For example, the system solves the computer-based problem of automatically informing users of potential items that may be purchased for delivery to the user. In the prior art, a user would need to directly contact the person via phone, email, text message, and the like. However, in the present invention, the system automatically determines a proper time to deliver required information to the user to allow them to elect to purchase items for certain customers for delivery. The provides better computerized functionality of the computerized alerting device because it solves the above noted technical problem, causes the device to operate more effectively, and addresses the internet specific problem of automated communications when the user is at or near a certain location. Indeed, the system may provide notifications to devices of multiple users and may provide real time tracking of accepted or rejected customer requests. Further, the system utilizes graphical user interface(s) to allow users and customers to operate the systems in unique, new, and non-obvious ways.

There exists a particular computerized and internet/network problem that it is difficult to track down neighbors and friends at stores unless one is specifically told that they are there at the time. Internet or networked connections of computerized devices equipped with a GPS receiver (or other location module) can track this (what friends/neighbors are at what stores). A computerized system of the present invention may thus be created that can identify locations of system users. When within a predetermined distance from a store, or when in the store, the system may identify his or her location and send or make available requests by system customers of items to purchase and delivery location. The user may then elect to purchase these items and may deliver them to the customer in exchange for payment or other compensation or consideration.

This invention performs a number of operations that could not be performed by a human using mental steps or pen and paper. For example, a non-computerized system could not automatically determine when a user is at a location or within a predetermined distance from a location. Further, once location is determined, a non-computerized operation could not inform a server of this fact, causing the server to automatically send the user a list of items to be purchased for a customer.

One important aspect of the present invention is the automatic determination and calculation of a so called “neighbor group” for a system user. The neighbor group is a group specific to a user of the system and is defined as a group of customers or potential customers who the user may purchase items for, and deliver these items. Neighbor groups may be fixed or dynamic, and a user may select parameters to determine the neighbor group contents. These parameters are elected by inputs into the computerized system by the user. For example, a user may allow the neighbor group to be limited to a radius about his home. Or, the user may allow the neighbor group to be within a predetermined distance or driving time from his home and/or off his driving route home. In another embodiment, a user may set a destination, and the computerized system may automatically generate a neighbor group based on proximity to the destination and/or distance from the driving route of the user.

In embodiments when the driving route distance is a factor of neighbor group calculations, the location of the user alerting device may be recorded using the location module and allows the user's neighbor group to be dynamically and frequently changed. A neighbor group for a user may be automatically calculated by the system based on location data, data entered by the user, and turn-by-turn direction systems that automatically determine optimal driving routes for the user based on the user's destination and/or home, and a location of potential customers in the neighbor group. When a device of the user is in networked (typically wireless) communication with the server, this networked group information may be dynamically updated based on movements of the user. Further if a request for item delivery is received by the server, it may be transmitted automatically to the user when at a store or within a zone about the store.

The computerized graphical user interface may be in communication with one or more computing devices in networked communication with each other. The computer or computers of the computerized user interface contemplated herein may comprise a memory, processor, and input/output system. In some embodiments, the computer may further comprise a networked connection and/or a display screen. These computerized elements may work together within a network to provide functionality to the computerized user interface. The computerized user interface may be any computerized interfaces capable of allowing a user to input data and receive a feedback. The computerized user interface may further provide outputs executed by the system contemplated herein.

In basic embodiments, the present invention provides a platform for neighbor to neighbor shopping and delivery service. A “user” or “shopper user” is defined herein as the entity performing the shopping and delivery, while the customer is defined herein as the entity receiving the delivery. As noted above, the neighbor group may be automatically determined and may be dynamic, though generally will be a group of customers that are easily accessible to the user so that delivery can be made without inconvenience. The system uses an alerting device to notify users who are in or near a particular store and provides requests on the alerting device with items requested for purchase and delivery instructions.

As generally implemented, the present invention provides a number of benefits including lower delivery costs because the “neighbor” is the shopper/driver, and the delivery distance is shorter than it would be for a dedicated deliverer. Further, because the user is simply shopping in-store, there is no product markup on the purchase price for the user, unless the system operates in a manner that marks up the prices. Moreover, shopping and delivery is done by neighbors, adding a level of trust not available to a complete stranger.

In one embodiment, the present invention may operate to alert potential customers when a user is at a store, and then the customers may then submit requests for item purchase. For example, once a user enters a store or is within a zone around the store, the user's computerized alerting device may signal this to the server. The server in turn may send a notification automatically to computerized devices of customers within the user's neighbor group.

In a particular embodiment, a database may be present on the server of the system that stores typical inventory items of common stores. In some cases this database may be in networked communication with an inventory system of a particular store for fully up to date inventory. As such, a customer may access the inventory of a store and select the particular items that the user knows will be present.

In many embodiments, customers may pre-enter their desired items into the system, which may be stored on the server. When a user having the members (customers) of his or her neighbor group with pre-entered data enters the store or a zone about the store, the server may automatically “push” this order request stored on the server to the user's alerting device. This notification, in some embodiments, may include display on the graphical user interface of a graphical representation alerting the requesting user, which may be accepted or rejected using gestures on a touch screen.

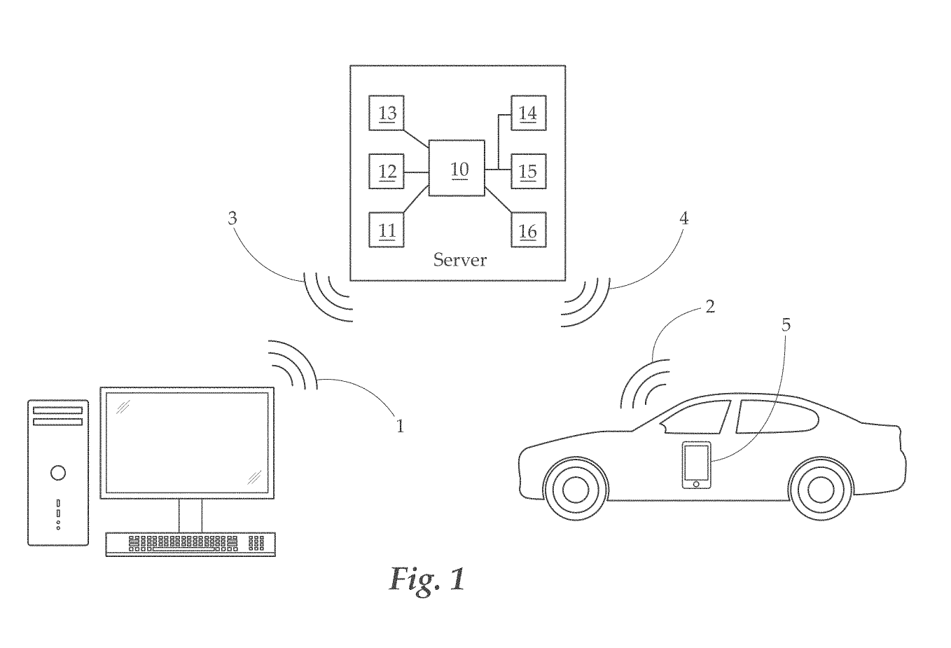

Turning now to FIG. 1, a view of an embodiment of the architecture of the present system invention is provided. A system customer computer, or computerized device, communicates remotely via paths 1 and 3 with the server 10. This server 10 is a computerized device that controls operation of the system by receiving inputs and providing outputs calculated based on these inputs and programming of the system. The server 10 includes a customer and user information storage memory 11. This memory 11 includes data regarding each user and customer, their locations, log in and other personal information, payment information, preferences, and so on. The server 10 uses this information to determine, among other things, which customer is in which user's neighbor group and thus which customers can be serviced by which users.

When a customer inputs an order request consisting of a list of items desired, store information, and delivery location (if not already stored in memory 11), this information may be stored in the existing orders storage module 12. The server 10 is configured to select appropriate existing orders of customers within a particular user's neighbor group and can then send them to the appropriate shopper user when any members of the neighbor group are in or near a particular store. In the embodiment shown, a database may be stored on the server 10 having an inventory information of one or multiple stores, formed as an inventory database storage 16. The customer may access this inventory database storage 16 through his or her computer and graphical user interface to view options for items to purchase at particular stores. The customer may then input these items for his or her order that is stored in the orders storage module 12.

A user location module 13 is in networked (likely wireless) communication with the user alert device 5 via communication paths 4 and 2. This module 13 receives a location data recorded from a location module of the user alert device 5. The server 10 is configured to use the information tracked by this module 13 to identify when the user alert device 5 is in, within a predetermined distance from, or in a predetermined zone about a particular store. Once entering this area, if an existing order in the storage 12 is pending for a customer in the user's neighbor group (i.e. a customer that would be convenient for the user to deliver to), this order is pushed to the user alert device 5 by the server via data path 4.

A neighbor group calculation module 14 is present on the server 10 that is configured to dynamically determine and update a group of potential customers that may be in a particular user's neighbor group. As noted above, the neighbor group for a user may be determined based on any combination of user preferences on how large the neighbor group should be and what parameters the user is willing to deliver to (near home, on route home, etc.), user location, user destination, and the like. This module 14 may monitor a user location, as determined by communication with the user alerting device via paths 4 and 2. As the location changes, if the user has selected to include neighbors on his route home, the neighbor group module 14 may dynamically calculate customers for the neighbor group based on a route to the user's destination based on GPS (or other location module) and turn by turn direction calculations. This module may communicate with the customer/user information storage memory 11 to retrieve information about user settings as well as customer location for the neighbor group calculations.

The server 10 further comprises a payment processing module 15. This module 15 allows automatic electronic payment to be transferred to a user from a customer. This payment may occur at various times during the process such as before, during, or after completion of purchase and/or delivery. In most embodiments, payment through the payment module 15 may be performed by electronic payment via stored credit card information, bank information, PayPal®, or other electronic payment system.

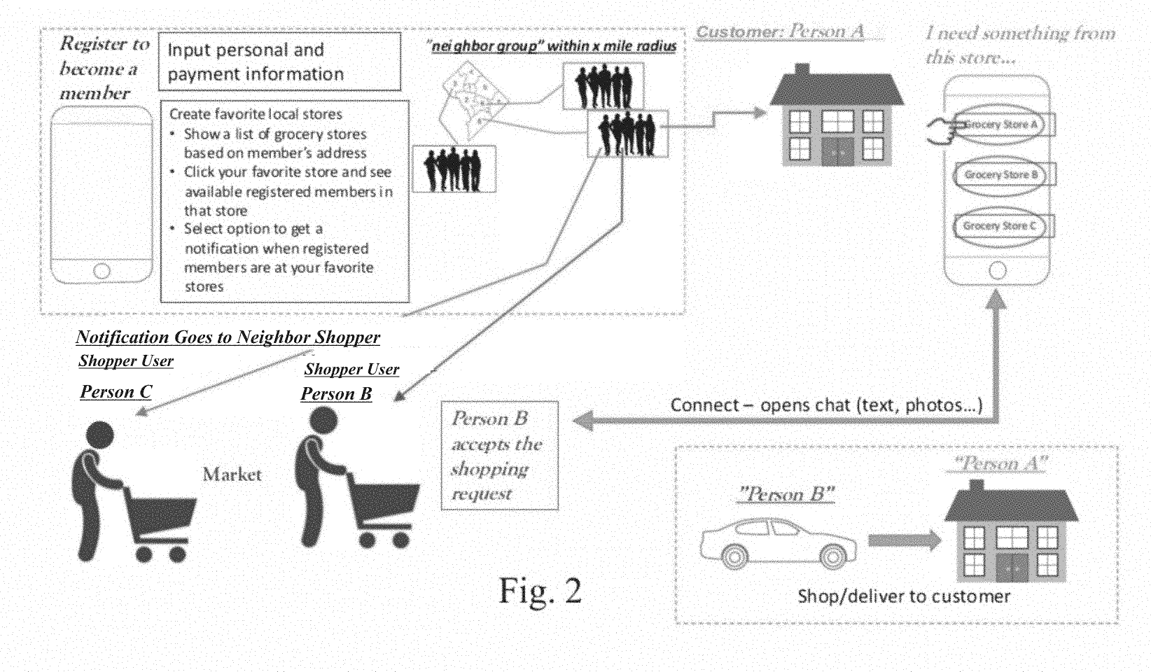

FIG. 2 provides a flow chart of an embodiment of the present invention. Beginning at the top left, a user or customer may sign up to become a member. In this embodiment, a new customer is signing up (it should be understood that users may also be customers, and vice versa). Initially the new customer inputs personal and payment information. Further, the customer may optionally enter a list of favorite local stores such as grocery stores. The store may be selected and registered users in or near the store may be identified.

In a particular embodiment, the customer's (person A) computerized device may also have a location module configured to determine the location of the computerized device. The location module in turn may determine a list of stores sorted by geographic proximity, and/or user preference. As such, if a customer user is travelling or away from his or her home, the system may still be utilized. Further still, this location information determined by the location module may be transmitted to the system computerized server. The server may in turn calculate and recalculate neighbor groups that the customer may be a member of.

Optionally, the system may be configured to notify the customer if and when a user in his or her neighbor group has entered or is in proximity to the store. The input information about the customer may be stored in the storage memory 11, and communications between the server 10 and customer user computer performed via data paths 1 and 3. Upon input of a requested order which is stored in the existing order storage 12, a notification may be sent via path 4 to user alert device(s) 5 of any users in or in proximity to the selected customer store. In the embodiment shown, two neighbor shopper users—person B and person C are in the selected store when they receive the customer order request from the existing orders storage 12 on the server 10 via path 4. The user alert device 5 for both person B and Person C receive and present notifications from the server. These alert devices 5 provide some sort of physical, visual, and/or audible alert to notify of a received request. Each user has the option to accept the shopping request—in this case, Person B is the acceptor.

Upon acceptance, information is sent to the user alert device 5 and a connection is made with information about the shopping order (this may also be sent prior to acceptance). Optionally, a chat or other communication link may be provided between the customer and the shopper user. This communication may be directly between the customer and the shopper user, or may be through the server via paths 1, 3, 4, and 2. Once the shopping is completed, Person B (the ‘user’) delivers the purchased items to Person A (the ‘customer’).

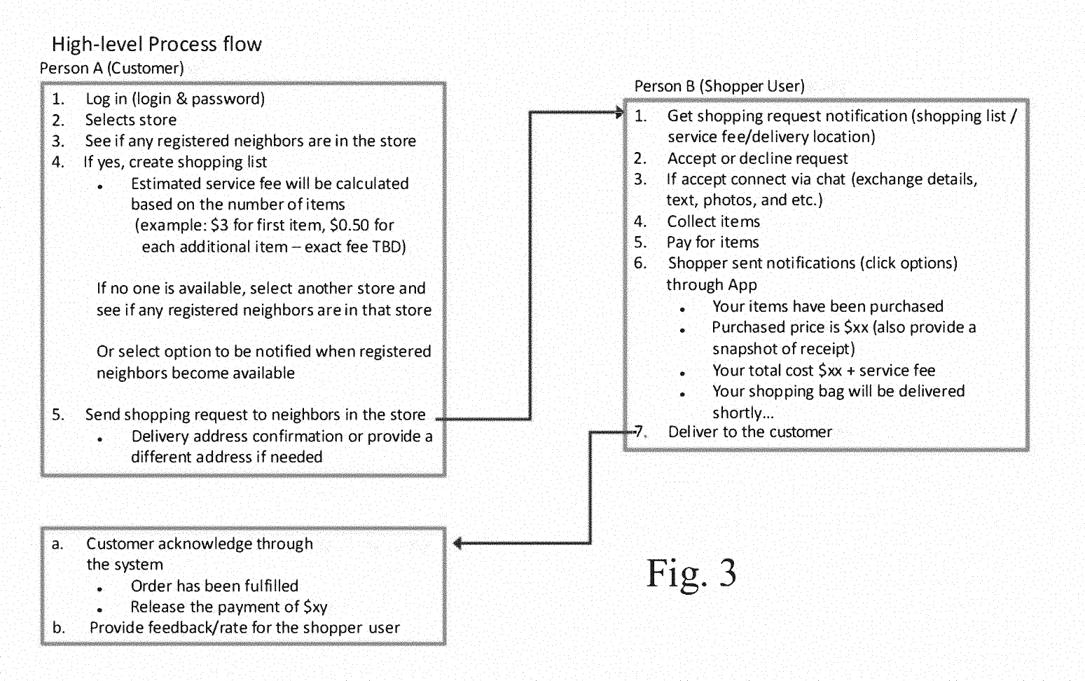

FIG. 3 provides a high level process flow of another embodiment of the Shopping and Delivery System. Initially, the customer, person A, may log in using a login and password. The customer may select a store and create a shopping list. Upon selecting the store, a customer may be notified if there are any users having the customer in his or her neighbor group that are in the store currently. If no one is available, the customer may either select another store, or may create a shopping list and have this list stored on the server for automatic notification to a user once he or she enters the store, is in proximity to the store, or enters a zone around the store. The system server may then send shopping requests to the shopper user(s) in the store, along with a delivery address confirmation, or the customer may provide a different address.

The shopper user, person B may receive shopping request notifications on his or her user alert device. The notification may include the shopping list, service fee, and delivery location. The user can then accept or decline the request. In this embodiment, if the request is accepted, the system may connect the user with the customer via a chat, text message communication, photograph exchange, and the like. The shopper may then collect the items and pay for them. The user alert device may then provide status updates to the server as the process proceeds. For example, the customer may be able to view that the items have been purchased, the purchase price, receipt photograph, total cost (purchase price plus service fee), notification that the user is en route, and so on. The user may then deliver the purchased items to the customer. Once received, the customer may acknowledge through his or her computerized device graphical user interface that the order has been fulfilled and may release the payment. Both customer and user may also provide feedback and rate the user and customer.

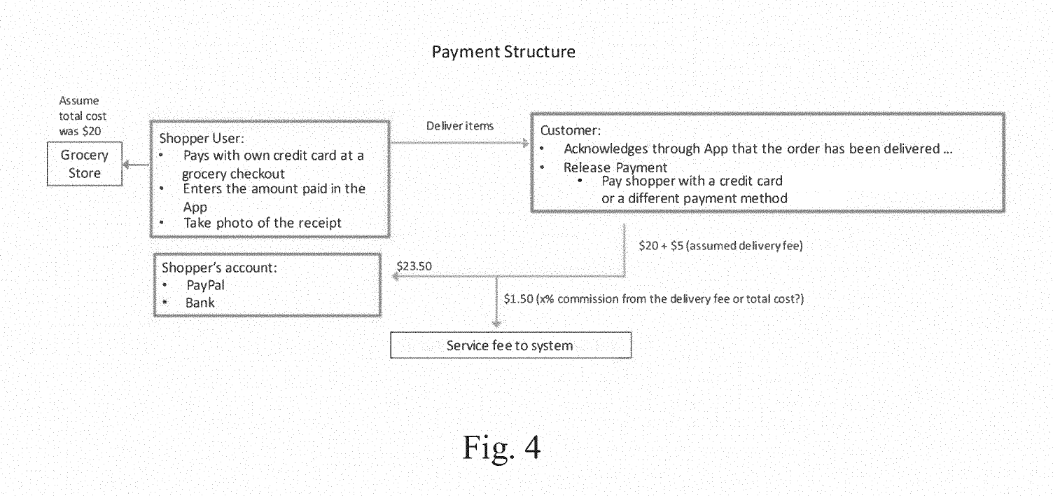

FIG. 4 provides an embodiment of a payment structure used for payment of users by customers. The example of this figure assumes a total order cost of $20. This is paid to the grocery store by the user, who pays with his or her own means (cash, check, credit card, and so on). The shopper user then enters the amount paid into his or her user alert device “App” (which herein refers to a user interface of a computerized application programmed to operate at least a portion of the functionality of the user alerting device), and takes a digital photograph of the receipt. This input and photo may be sent to the server for recording in memory. The user then delivers items to the customer. The customer, once receiving the items may acknowledge receipt and release payment. The customer may pay the user through a credit card in the service account, or through other electronic payment means. In this embodiment, there is a $5 service fee to the customer, of this fee, $3.50, plus the $20 paid by the user is paid back to the user for a total of $23.50; while $1.50 is transferred to the service system for operation, maintenance, and profit.

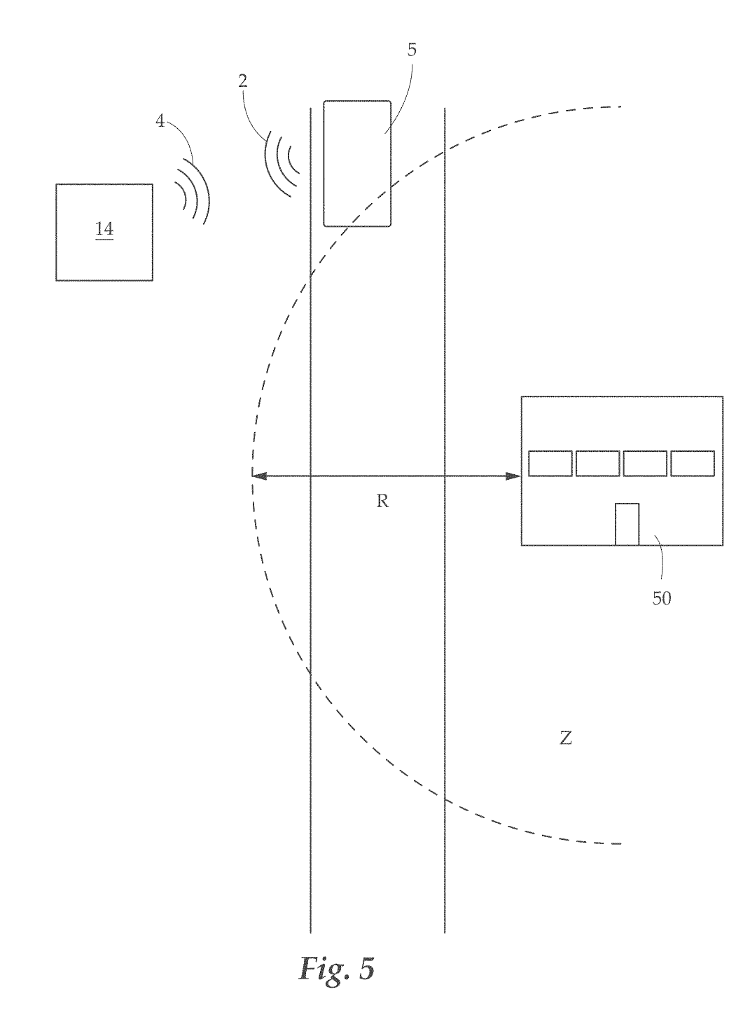

FIG. 5 provides a schematic view of an embodiment of the system that tracks when a user's alerting device 5 is within a zone Z in proximity to a store 50. The user alerting device 5 is equipped with a GPS receiver and transmitter or other location module. The alerting device 5 communicates wirelessly with server 10 via signals 2 and 4. The server 10 is configured to identify a coordinate location of known store locations and store this information in memory. Further, the server 10 may calculate a zone z around the store as a coordinate range. In this embodiment, zone z is defined as a circle having a radius R around the store. In other embodiments, the zone may be extended out to a common road or highway near the store to maximize notifications to the user alerting device 5. When the user alerting device 5, in this case a smartphone travelling in a vehicle, passes within or through this zone, the server 10, through various modules, identifies this and can alert potential customers who may wish to request items for delivery, and/or the server can send stored requests to the user alerting device 5.

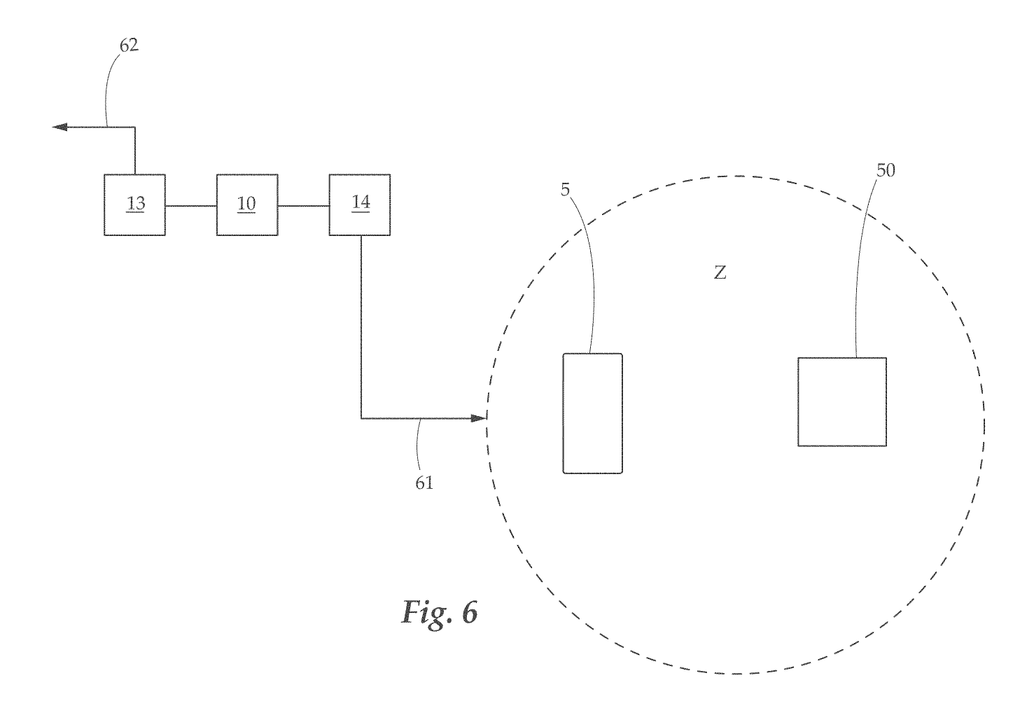

FIG. 6 provides a view of a data flow embodiment of how the system detects that a user alerting device is within a store zone, and provides communications to the user alerting device and to a customer's computerized device. In this view, when a GPS receiver (or other location module) of the user alerting device 5 is within a zone Z around store 50 (this may be either detected by the server 10, or communicated to the user alerting device 5 if the user alerting device is programmed to identify that it is within a zone about a store). The user alerting device 5 communicates with the neighbor group calculation module 14 of the server 10 via path 61. In varying embodiments, the user alerting device 5 may also communicate with the user location module 13, and other modules of the server 10. The user location module 13 communicates with the client via path 62 and may alert the customer that a user has received his or her order, that a user is near a store and may accept the order, and the like.

In a further embodiment, the present invention may utilize a processor of the user alerting device to operate a graphical user interface on a touch screen display. In an embodiment of operation, the processor may cause the graphical user interface to display the order notification as a graphical representation. Upon receiving a gesture, such as a tap, swipe, two fingered pinch or extend, and the like, the processor may determine that the graphical user interface has received an acceptance indication regarding the graphical representation of the notification. Upon receipt of this determination, the processor may signal to the server of this acceptance, and may cause the graphical user interface to display further details regarding the customer request, such as a shopping list, customer information, and the like as this data is received from the server.

Further, the graphical user interface, touch screen, and processor of the user alerting device may be operable to receive a second gesture on a list of items for purchase to indicate that the item has been obtained. Gestures of the second gesture may be a tap, swipe, two fingered pinch or extend, and the like. The processor may then cause the graphical user interface to display an indication that the item is obtained, such as by putting a check mark next to the item, removing the item for the displayed list, striking through a text of the item, and so on.

As noted above, a communications link may be provided between the customer and the shopper user. In one embodiment, this may be implemented on the user alerting device by the processor causing the graphical user interface to display a text area and a keyboard. The keyboard is operable by a receipt of a gesture on a representation of a key, this instructs the processor to display the series of letters “typed” in the text box. A gesture on a send button may then cause the processor to transmit this message to the customer, either through server based communications or directly using a cellular, cellular data, or other similar networked connection.

Once a user has purchased the requested items for the customer, the delivery begins. In one embodiment, the processor of the user alerting device may provide turn by turn directions, using the graphical user interface, to the user. Part of this operation may include displaying a map with a visual indicator of a location of the customer which is caused to be displayed by the processor on the display of the device. Further, on a customer user interface, in one embodiment the graphical user interface may be configured to display a map with an updating location of the user. This may allow a customer to track delivery status and to know when to expect a user delivering the ordered items.

After delivery, the processor may be configured to receive a gesture to the touch screen on a graphical representation presented on the graphical user interface to confirm that the items have been received by the customer.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

Those skilled in the art will readily observe that numerous modifications, applications and alterations of the device and method may be made while retaining the teachings of the present invention.

What is claimed is:

1. A system for coordinating item shopping and delivery comprising:
a computerized alerting device comprising a processor, a memory, an alerting mechanism, a location module configured to determine a coordinates of a physical location of the computerized alerting device, a touch screen display, and a battery providing power to the device;
a computerized server in wireless communication with the computerized alerting device, the communication between the computerized server and computerized alerting device comprising a recordation of the determined location of the computerized alerting device by the computerized server;
wherein the computerized server is configured to provide a notification to the computerized alerting device when the location of the computerized alerting device is within a predetermined zone around a retail store, the notification comprising a request for a purchase of at least one item from the retail store, the predetermined zone around a retail store being a coordinate range stored in a memory on at least one of the computerized server or the computerized alerting device;
wherein the computerized server is configured to calculate a neighbor group of customers having data stored on the computerized server, the neighbor group calculated based on a delivery location in proximity to one of a shopper user destination, a shopper user path to destination, and a shopper user's location, the computerized server configured to send the request for the purchase of the at least one item from the retail store to the computerized alerting device only if the request comes from a customer of the calculated neighbor group of customers.

2. The system of claim 1 wherein the computerized server is further configured to automatically provide an output to the customers of the calculated neighbor group when the computerized alerting device is within the predetermined zone, the output alerting the customers of the calculated neighbor group that a shopper user of the computerized alerting device may receive item purchase requests for delivery.

3. The system of claim 1 wherein the computerized server comprises an existing orders storage module, the existing order storage module comprising a memory storing a plurality of existing orders of at least one item to be purchased by the shopper user, the computerized server configured to send notification containing all of the existing orders of the plurality of existing orders of customers belonging to the calculated neighbor group to the computerized alerting device when the shopper user enters the predetermined zone.

4. The system of claim 1 wherein the computerized server comprises an information storage memory storing a plurality of information for a plurality of customers and a plurality of shopper users.

5. The system of claim 1 further comprising a store inventory database configured to contain a quantity of information relating to items available at the retail store.

6. The system of claim 1 wherein the computerized alerting device is configured to provide a visual alert on the touch screen display.

7. The system of claim 1 wherein the computerized alerting device is configured to provide an audible alert.

8. The system of claim 1 wherein the computerized alerting device is configured to provide a vibrating alert.

9. The system of claim 1 wherein the retail store is a grocery store, and wherein the request for purchase of the at least one item is a grocery list.

10. The system of claim 1 wherein the calculated neighbor group is recalculated by the computerized server based on a change in location of the shopper user computerized alerting device, the change in location transmitted to the computerized server and determined by the location module.

11. The system of claim 4 wherein the calculated neighbor group is calculated by a set of user preference settings stored in the information storage memory of the computerized server.

12. The system of claim 1 wherein the computerized server is configured to provide a payment to the shopper user from the customer of the neighbor group after a delivery of the requested at least one item.

13. The system of claim 1 wherein the computerized alerting device comprises a camera in electronic communication with the processor, the processor configured to receive a photograph of at least one of a receipt and the at least one item for purchase.

14. The system of claim 1 wherein the computerized alerting device further comprises a graphical user interface operable through the touch screen display, the processor operable to:
cause the graphical user interface to display the notification;
determine that the graphical user interface has received an acceptance indication regarding the notification at least by determining that a gesture associated with the notification displayed on the graphical user interface is received;
automatically cause the graphical user interface to display a list of the at least one item for purchase from the retail store.

15. The system of claim 14 wherein the processor is further operable to determine that a second gesture associated with one item of the list of the at least one item for purchase has been received on the touch screen display; and operable to automatically display on the graphical user interface an indication that the at least one item for purchase is obtained after determining that the second gesture is received.

16. The system of claim 14 wherein the processor is operable to enable communication between the shopper user of the computerized alerting device and the customer; and
in response to the enablement of communication between the shopper user and the customer, cause the graphical user interface to display to the shopper user a text area, the text area configured to receive text inputted by the shopper user through the touch screen to send to the customer.

17. The system of claim 14 wherein the processor is further operable to cause the user interface to display a map having an indicator of a location of the customer for delivery to the customer.

18. The system of claim 15 wherein the processor is configured to receive a third gesture on the touch screen after the shopper user has delivered the at least one for purchase to the customer.

19. The system of claim 1 wherein the zone around the store is automatically calculated by the computerized server to be a predetermined radius from the store.

20. The system of claim 1 wherein the zone around the store is extended to coordinates spanning at least one street adjacent to the store.
